(19) United States
(12) Patent Application Publication
(10) Pub. No.: US 2022/0164580 A1
(43) Pub. Date: May 26, 2022

(54) FEW SHOT ACTION RECOGNITION IN UNTRIMMED VIDEOS

(71) Applicants: Yixiong Zou, Beijing (CN); Shanghang Zhang, Pittsburgh, PA (US); Guangyao Chen, Beijing (CN); Yonghong Tian, Beijing (CN); CARNEGIE MELLON UNIVERSITY, Pittsburgh, PA (US)

(72) Inventors: José M.F. Moura, Pittsburgh, PA (US); Yixiong Zou, Beijing (CN); Shanghang Zhang, Pittsburgh, PA (US); Guangyao Chen, Beijing (CN); Yonghong Tian, Beijing (CN)

(21) Appl. No.: 17/529,011

(22) Filed: Nov. 17, 2021

Related U.S. Application Data
(60) Provisional application No. 63/117,870, filed on Nov. 24, 2020.

(51) Int. Cl. G06K 9/00; G06K 9/62; G06N 20/00

(52) U.S. Cl. CPC G06K 9/00718; G06K 9/6256; G06N 20/00; G06K 9/00744; G06K 9/6228; G06K 9/6262

(57) ABSTRACT

Disclosed herein is a method for performing few shot action classification and localization in untrimmed videos, where novel-class untrimmed testing videos are recognized with only few trimmed training videos (i.e., few-shot learning), with prior knowledge transferred from un-overlapped base classes where only untrimmed videos and class labels are available (i.e., weak supervision).

### RELATED APPLICATIONS

This application claims the benefit of U.S. Provisional Patent Application No. 63/117,870, filed Nov. 24, 2020, the contents of which are incorporated herein in their entirety.

### BACKGROUND

Deep learning techniques have achieved great success in recognizing action in video clips. However, to recognize action in videos, the training of deep neural networks still requires large amount of labeled data, which makes the data collection and annotation laborious in two aspects: first, the amount of required annotated data is large, and, second, temporally annotating the start & end time (location) of each action is time-consuming. Additionally, the cost and difficulty of annotating videos is much higher than annotating images, thereby limiting the realistic applications of existing methods. Therefore, it is highly desirable to provide for the reduction of the requirement to provide annotations for video action recognition.

To reduce the need for many annotated samples, few-shot video recognition recognizes novel classes with only a few training samples, with prior knowledge transferred from un-overlapped base classes where sufficient training samples are available. However, most known methods assume the videos are trimmed in both base classes and novel classes, which still requires temporal annotations to trim videos during data preparation. To reduce the need to annotate action locations, untrimmed video recognition could be used. However, some known methods still require temporal annotations of the action location. Other known methods can be carried out with only weak supervision (i.e., a class label), under the traditional closed-set setting (i.e., when testing classes are the same as training classes), which still requires large amounts of labeled samples.

Thus, the few-shot untrimmed video recognition problem remains. Some known methods still require full temporal annotations for all videos, while other known methods require large amounts of trimmed videos (i.e., “partially annotated”). There are no known methods that address both of these difficulties simultaneously.

### SUMMARY OF THE INVENTION

Disclosed herein is a method for performing few shot action classification and localization in untrimmed videos, where novel-class untrimmed testing videos are recognized with only a few trimmed training videos (i.e., few-shot learning), with prior knowledge transferred from un-overlapped base classes where only untrimmed videos and class labels are available (i.e., weak supervision).

FIG. 1 illustrates the problem. There are two disjoint set of classes (i.e., base classes 102 and novel classes 104). The model presented herein is first trained on base classes 102 to learn prior knowledge, where only untrimmed videos with class labels are available. Then, the model conducts few-shot learning on non-overlapping novel classes 104 with only a few trimmed videos. Finally, the model is evaluated on untrimmed novel-class testing videos 106 by classification and action detection.

Note that, although on the novel-class training set trimmed videos are required, the annotation cost is limited as only very few samples (e.g., 1-5 samples per novel class) need to be temporally annotated.

The proposed problem has the following two challenges: (1) untrimmed videos with only weak supervision: videos from the base class training dataset and the novel class testing dataset are untrimmed (i.e., containing non-action video background segments, referred to here as “BG”), and no location annotations are available for distinguishing BG and the video segments with actions (i.e., foreground segments, referred to herein as “FG”). (2) overlapped base class background and novel class foreground: BG segments in base classes could be similar to FG segments in novel classes with similar appearances and motions. That is, unrecognized action (i.e., action not falling into one of the base classes) may be the action depicted in a novel class.

For example, in FIG. 1, frames outlined in red and blue in base classes are BG, but the outlined frames in novel classes are FG, which share similar appearances and motions with the frame outlined in the same color. This problem exists because novel classes could contain any kinds of actions not in base classes, including the ignored actions in the base class background. If the model learns to force the base class BG to be away from the base class FG, it will tend to learn non-informative features with suppressed activation on BG. However, when transferring knowledge to novel class FG with similar appearances and motions, the extracted features will also tend to be non-informative, harming the novel class recognition. Although this difficulty widely exists when transferring knowledge to novel classes, the method disclosed herein is the first attempt to address this problem.

To address the first challenge, a method for BG pseudo-labeling or to softly learn to distinguish BG and FG by the attention mechanism is disclosed. To handle the second challenge, properties of BG and FG are first analyzed. BG can be coarsely divided into informative BG (referred to herein as “IBG”) and non-informative BG (referred to herein as “NBG”).

For NBG, there are no informative objects or movements, that is, NBG are video segments containing no action. For example, the logo at the beginning of a video (like the left most frame of second row in FIG. 1) or the end credits at the end of a movie, which are not likely to cue recognition. IGB, on the other hand, are video segments containing non-base class action (i.e., action not classifiable by the base class model). For IBG, there still exist informative objects or movements in video segments, such as the outlined frames in FIG. 1, which could possibly be the FG of novel-class video segments, and thus should not be forced to be away from FG during the base class training. For NBG, the model should compress its feature space and pull it away from FG, while for IBG, the model should not only capture the semantic objects or movements in it, but also still be able to distinguish it from FG. Current methods simply view NBG and IBF equivalently and, thus, tend to harm the novel-class FG features.

The method disclosed herein handles these two challenges by viewing NBG and IBG differently. The method focuses on the base class training. First, to find NBG, an open-set detection based method for segment pseudo-labeling is used, which also finds FG and handles the first challenge by pseudo-labeling BG. Second, a contrastive learning method is provided for self-supervised learning of informative objects and motions in IBG and distinguishing NBG. Third, to softly distinguish IBG and FG as well as to alleviate the problem of great diversity in the BG class, each video segment's attention value is learned by its transformed similarity with the pseudo-labeled BG (referred to herein as a “self-weighting mechanism”), which also handles the first challenge by softly distinguishing BG and FG. Finally, after base class training, nearest neighbor classification and action detection is performed on novel classes for few-shot recognition.

By analyzing the properties of BG, the method provides (1) an open-set detection based method to find the NBG and FG, (2) a contrastive learning method for self-supervised learning of IBG and distinguishing NBG, and (3) a self-weighting mechanism for the better distinguishing between IBG and FG.

### BRIEF DESCRIPTION OF THE DRAWINGS

FIG. 1 shows exemplary base classes, exemplary novel classes and an exemplary testing dataset.

FIG. 2 is a block diagram of one possible embodiment of an implementation of the method described herein.

FIG. 3 is a block diagram showing one possible implementation of the feature extractor used in the base class model.

### DETAILED DESCRIPTION

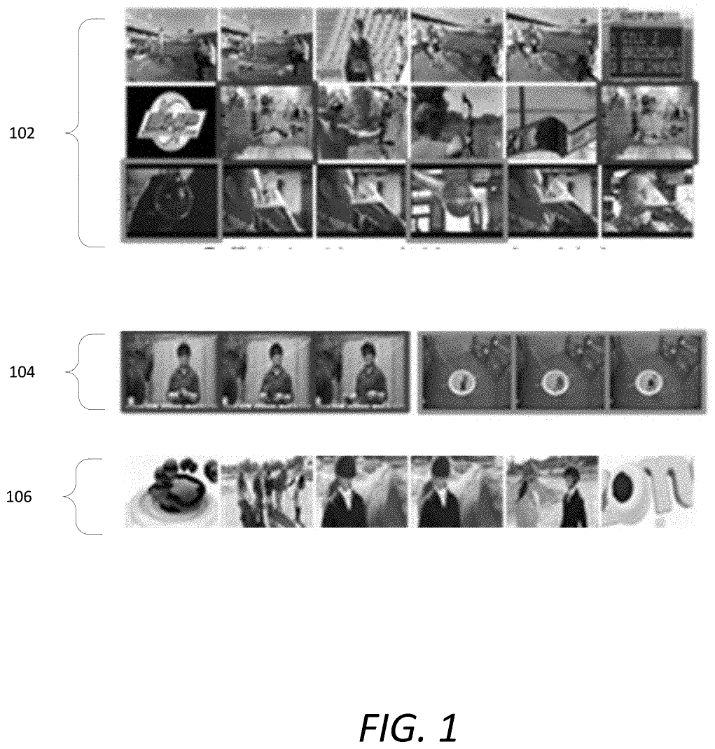

To define the problem formally, assume there are two disjoint datasets [symbol] _{base} and Dₙₒᵥₑₗ, with base classes [symbol] _{base} and novel classes [symbol] ₙₒᵥₑₗ respectively. Note that [symbol] _{base}∩ [symbol] ₙₒᵥₑₗ={ }. For [symbol] _{base}, sufficient training samples are available, while for [symbol] ₙₒᵥₑₗ, only few training samples are accessible (i.e., few-shot training samples). As shown in FIG. 1, the model is first trained on [symbol] _{base} for prior knowledge learning, and then the model is trained on the training set (i.e., a “support set”) of [symbol] ₙₒᵥₑₗ for the learning with just a few samples. Finally, the model is evaluated on the testing set (i.e., a “query set”) of [symbol] ₙₒᵥₑₗ. For fair comparison, usually there are K classes in the support set and n training samples in each class (i.e., “K-way n-shot”). Therefore, during the novel class period, numerous K-way n-shot support sets with their query sets will be sampled. Each pair of support set and query set can be viewed as an individual small dataset (i.e., an “episode”) with its training set (i.e., “support set”) and testing set (i.e., “query set”) that share the same label space. For novel classes, the sampling-training-evaluating procedure will be repeated on thousands of episodes to obtain the final performance.

Current few-shot learning (“FSL”) methods for videos assume trimmed videos in both [symbol] _{base} and [symbol] ₙₒᵥₑₗ, which is less realistic due to the laborious temporal annotation of action locations. In another stream of current methods, few-shot untrimmed video recognition can be performed on untrimmed videos under an FSL setting, but still requires either the full temporal annotation or the partial temporal annotation (i.e., large amounts of trimmed videos) on base classes for distinguishing the action part (FG) and non-action part (BG) of video. As base classes require large amounts of data preparation of appropriate datasets is still costly.

To solve this problem, in the disclosed method, referred to herein as “Annotation-Efficient Video Recognition”, [symbol] _{base} contains only untrimmed videos with class labels (i.e., weak supervision) and [symbol] ₙₒᵥₑₗ contains only a few trimmed videos used for the support set, while untrimmed videos are used for query set for action classification and detection. Note that, although trimmed videos are needed for the support set, the cost of temporal annotation is limited since only a few samples need be temporally annotated.

The challenges are thus recognized in two aspects: (1) Untrimmed video with only weak supervision, which means noisy parts of the video (i.e., BG) exist in both base and novel classes; and (2) Overlapped base class background and novel-class foreground, which means BG segments in base classes could be similar or identical to FG in novel classes with similar semantic meaning. For example, in FIG. 1, the outlined frames outlined in base classes are BG, but the outlined frames in novel classes are FG, which share similar appearances or motions with the frame outlined in the same color.

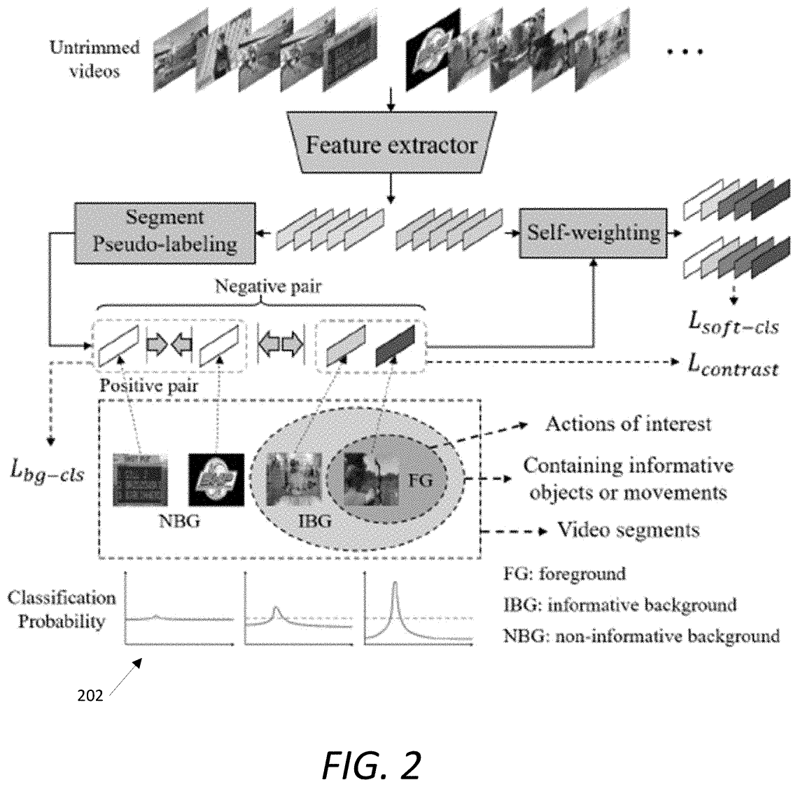

The framework of the disclosed method is schematically shown in FIG. 2. A baseline model is first provided based on baselines of FSL and untrimmed video recognition. Then, modifications to this model in accordance with the method of the present invention are specified.

For FSL, a widely adopted baseline model first classifies each base class video x into all base classes [symbol] _{base}, then uses the trained backbone network for feature extraction. Finally, nearest neighbor classification is conducted on novel classes based on the support set and query set. The base class classification loss is specified as:

$${L}_{cls} = - {\sum }_{i = 1}^{N} {y}_{i} log ( \frac{{e}^{τ {W}_{i} F ( x )}}{{Σ}_{k = 1}^{N} {e}^{τ {W}_{k} F ( x )}} ) \qquad ( 1 )$$

where:
yᵢ=1 if x has the i^{th} action, otherwise yᵢ=0;
F(x)∈R^{d×1} is the extracted video feature;
d is the number of channels;
τ is the temperature parameter and is set to 10.0;
N is the number of base classes; and
W∈R^{N×d} is the parameter of the fully-connected (FC) layer for base class classification (with the bias term abandoned).

Note that F(x) is L2 normalized along columns and W is L2 normalized along rows. The novel-class classification is based on:

$$= \{ {y}_{i} \vert P ( {y}_{i} \vert {x}_{q}^{U} ) > {t}_{a} \} = \{ i \vert \frac{{e}^{s ( F ( {x}_{q}^{U} ) , {p}_{i}^{U} )}}{{Σ}_{k = 1}^{K} {e}^{s ( F ( {x}_{q}^{U} ) , {p}_{k}^{U} )}} > {t}_{a} \} \qquad ( 2 )$$

where:
x_{q}^{U} is the novel class query sample to classify; [symbol]
is its predicted label(s);
tₐ denotes the action threshold;
s(,) denotes the similarity function (e.g., cosine similarity);
K is the number of classes in the support set; and
pᵢ^{U} is the prototype for each class.

Typically, the prototype is calculated as

$${p}_{i}^{U} = \frac{1}{n} {\sum }_{j = 1}^{n} F ( {x}_{ij}^{U} )$$

where xᵢⱼ^{U} is the j^{th} sample in the i^{th} class and n is the number of samples in each class.

For untrimmed video recognition, to obtain the video feature F(x) given x, each video is split into T overlapped or un-overlapped video segments, where each segment contains t consecutive frames. Thus, the video can be represented as x={sᵢ}ᵢ₌₁^{T} where sᵢ is the i^{th} segment. As BG exists in x, segments contribute unequally to the video feature. Typically, one widely used baseline is the attention-based model, which learns a weight for each segment by a small network, and uses the weighted combination of all segment features as the video feature as:

$$F ( x ) = {\sum }_{i = 1}^{T} \frac{h ( {s}_{i} )}{{Σ}_{k = 1}^{T} h ( {s}_{k} )} f ( {s}_{i} ) \qquad ( 3 )$$

where:
ƒ(sᵢ)εR^{d×1} is the segment feature, which could be extracted by a 3D convolutional network; and
h(sᵢ) is the weight for sᵢ.

The above baseline is denoted as the soft-classification baseline. The modifications to the baseline introduced by this invention are disclosed below.

To address the challenge of untrimmed videos with weak supervision, a method is developed for BG pseudo-labeling or to softly learn to distinguish BG and FG by the attention mechanism. To handle the challenge of overlapped base class BG and novel class FG, the properties of BG and FG are first analyzed.

BG does not contain the action of interest, which means by removing these parts of video segments, the remaining parts (i.e., FG) could still be recognized as the action of interest (i.e., an action able to be classified as one of the base class actions). Current methods either only utilize the FG in classification or softly learn large weights for FG segments and learn small weights for BG segments, which makes the supervision from class labels less effective for the model to capture the objects or movements in BG segments.

Additionally, BG shows great diversity, which means any videos, as long as they are not relevant to the current action of interest, could be recognized as BG. However, novel classes could also contain any kinds of actions not in base classes, including the ignored actions in the base class BG, as shown in FIG. 1. Deep networks tend to have similar activation given input with similar appearances. If novel class FG is similar to base class BG, the deep network might fail to capture semantic objects or movements, as it does on base classes.

However, in the infinite space of BG, empirically, not all video segments could be recognized as FG. For example, in the domain of human action recognition, only videos with humans and actions could be recognized as FG. Video segments that provide no information about humans are less likely to be recognized as FG in the vast majority of classes, such as the logo page at the beginning of a video, or the end credits at the end of a movie, as shown in FIG. 1. Therefore, the BG containing informative objects or movements are categorized as IBG, and the BG containing less information background are categorized as NBG. For NBG, separating it from FG is less likely to prevent the model from capturing semantic objects or movements in novel-class FG, while for IBG, forcing it to be away from FG would cause such a problem. Therefore, it is important to view these two kinds of BG differently.

For NBG, the model compresses its feature space and pulls the NBG away from FG, while for IBG, the model not only captures the semantic objects or movements in it but is also still be able to distinguish IBG from FG. Based on the above analysis, the disclosed method solves these challenges. As shown in FIG. 2, model of the disclosed invention can be summarized as (1) finding NBG; (2) self-supervised learning of IBG; and (3) the automatic learning of IBG and FG.

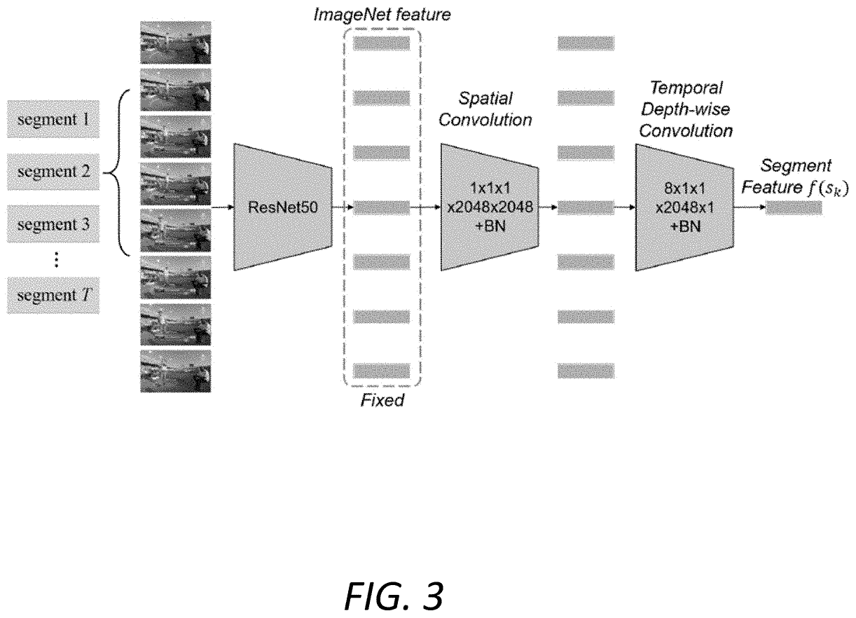

Finding NBG—The NBG seldom share semantic objects and movements with FG. Therefore, empirically its feature would be much more distant from FG than the IBG, with its classification probability being much closer to the uniform distribution, as shown in FIG. 3, reference number 202. Given an untrimmed input x={sᵢ}ᵢ₌₁^{T} and N base classes, BGs can be identified by each segment's maximum classification probability as:

$${i}_{b g} = argmin max P ( {s}_{k} ) \qquad ( 4 )$$

where:
i_{bg} is the index of the BG segment;
P(sₖ)∈R^{N×1} is the base class logit, calculated as Wƒ(sₖ); and
ƒ(sₖ) is also L₂ normalized.

For simplicity, the pseudo-labeled BG segment sᵢ_{_{bg}} is denoted as s_{bg}. Then, NBG are pseudo-labeled by filtering its max logit as:

$$\{ {s}_{n b} \} = \{ {s}_{b g} \vert max P ( {s}_{b g} ) < {t}_{n} \} \qquad ( 5 )$$

where:
s_{nb} denoted the pseudo-labelled NBG; and
tₙ is the threshold.

In the domain of open-set detection, the pseudo-labeled segment can be viewed as the known-unknown sample, for which another auxiliary class can be added to classify it. Therefore, a loss is applied for the NBG classification as:

$${L}_{bg \text{-} c l s} = - log ( P ( {y}_{n b} \vert {s}_{n b} ) ) = - log ( \frac{{e}^{τ {W}_{n b}^{E} f ( {s}_{n b} )}}{{Σ}_{i = 1}^{N} {e}^{τ {W}_{i}^{E} f ( {s}_{n b} )}} ) \qquad ( 6 )$$

where:
W^{E}∈R^{(N+1)×d} denotes the FC parameters expended from W to include the NBG class; and
y_{nb} is the label of the NBG.

Self-Supervised Learning of IBG and Distinguishing NBG—While FG is informative of current actions of interest, containing informative objects and movements, IBG is not informative of current actions of interest, but contains informative objects and movements, and NBG is neither informative of current actions nor contains informative objects or movements. The correlation between these three terms is shown in FIG. 2. As the supervision from class labels could mainly help distinguishing whether one video segment is informative of recognizing current actions, the learning of IBG could not merely rely on the classification supervision because IBG is not informative enough of that task. Therefore, other supervisions are needed for the learning of IBG.

To solve the problem of overlapped base class BG and novel class FG, the model captures the informative things in IBG, which is just the difference between NBG and IBG+FG. A contrastive learning method can be developed by enlarging the distance between NBG and IBG+FG.

Currently, contrastive learning has achieved great success in self-supervised learning, which learns embedding from unsupervised data by constructing positive and negative pairs. The distances within positive pairs are reduced, while the distances within negative pairs are enlarged. The maximum classification probability also measures the confidence that the given segment belongs to one of the base classes, and FG always shows the highest confidence. Such criteria is also utilized for pseudo-labeling FG, which is symmetric to the BG pseudo-labeling. Segments are not only pseudo-labelled with the highest confidence segments as the FG segments, but also includes some segments with relatively high confidence as the pseudo-labeled IBG. Because IBG shares informative objects or movements with FG, its action score should be smoothly decreased from FG. Therefore, the confidence score between FG and IBG could be close. Thus, it is difficult to set a threshold for distinguishing FG and IBG. However, the aim is not to distinguish them in this loss, and, therefore, segments could simply be chosen with top confidences to be the pseudo-labeled FG and IBG, and features from NBG and FG+IBG marked as the negative pair, for which the distance needs to be enlarged.

For the positive pair, because the feature space of NBG needs to be compressed, two NBG features are marked as the positive pair, for which the distance needs to be reduced. Note that features from the FG and IBG cannot be set as the positive pair, because IBG does not help the base class recognition, thus such pairs would harm the model.

Specifically, given a batch of untrimmed videos with batch size B, all NBG segments {s_{bg}^{j}}ⱼ₌₁^{B} and FG+IBG segments {s_{fg+ibg}^{j}}ⱼ₌₁^{B} are used to calculate the contrastive loss as:

$${L}_{contrast} = {max}_{j \neq k} d ( f ( {s}_{nb}^{j} ) , f ( {s}_{nb}^{k} ) ) + β max ( 0 , margin - min d ( f ( {s}_{fg + ibg}^{j} ) , f ( {s}_{nb}^{k} ) ) ) \qquad ( 7 )$$

### Where:

d(,) denotes the squared Euclidean distance between two L₂ normalized vectors; and
margin is set to 2.0.

Automatic learning of IBG and FG—The separation of IBG from FG cannot be explicitly forced, but the model should still be able to distinguish IBG from FG. To achieve this goal, the attention-based baseline model is used, which automatically learns to distinguish BG and FG by learning a weight for each segment via a global weighting network. However, this model has one drawback: it assumes a global weighting network for the BG class, which implicitly assumes a global representation of the BG class. However, the BG class always shows great diversity, which is even exaggerated when transferring the model to un-overlapped novel classes, because greater diversity not included in the base classes could be introduced in novel classes. This drawback hinders the automatic learning of IBG and FG.

The solution is to abandon the assumption about the global representation of BG. Instead, for each untrimmed video, its pseudo-labeled BG segment is used to measure the importance of each video segment, and its transformed similarity is used as the attention value, which is a self-weighting mechanism.

Specifically, the pseudo-labeled BG segment for video x={sᵢ}ᵢ₌₁^{T} is denoted as s_{bg}, as in Eq. (4). Because the feature extracted by the backbone network is L₂ normalized, the cosine similarity between s_{bg} and the k^{th} segment sₖ can be calculated as ƒ(s_{bg})^{T}ƒ(sₖ). Therefore, a transformation function can be designed, based on ƒ(s_{bg})^{T} ƒ(sₖ), to replace the weighting function h( ) in Eq. (3) (i.e., h(sₖ)=g(ƒ(s_{bg})^{T} ƒ(sₖ))). Specifically, the function is defined as:

$$g ( {f ( {s}_{b g} )}^{⊤} f ( {s}_{k} ) ) = \frac{1}{1 + {e}^{- {τ}_{s} ( 1 - c - {f ( {s}_{{b}_{t} q} )}^{⊤} f ( {s}_{k} ) )}} \qquad ( 8 )$$

where:
τₛ controls the peakedness of the score and is set, in some embodiments, to 8.0; and
c controls the center of the cosine similarity, which is set, in some embodiments, to 0.5.

The function is designed as such because the cosine similarity between ƒ(s_{bg}) and ƒ(sₖ) is in the range [−1, 1]. To map the similarity to [0, 1], a sigmoid function is added, and τₛ is added to ensure the max and min weight are close to 0 and 1. Because two irrelevant vectors should have cosine similarity of 0, the center c of the cosine similarity is set to 0.5. Note that this mechanism is different from the self-attention mechanism, which uses an extra global network to learn the segment weight from the segment feature itself. Here the segment weight is the transformed similarity with the pseudo-labeled BG, and there are no extra global parameters for the weighting. The modification of the classification in Eq. (1) is:

$${L}_{cls \text{-} soft} = - log ( \frac{{e}^{τ {W}_{y}^{E} F ( x )}}{{Σ}_{i = 1}^{N + 1} {e}^{τ {W}_{i}^{E} F ( x )}} ) \qquad ( 9 )$$

where:
W^{E}∈R^{(N+1)×d} are the FC parameters expanded to include the BG class as in Eq. (6); and
F(x) in Eq. (3) is modified as:

$$F ( x ) = {\sum }_{i = 1}^{T} \frac{g ( {f ( {s}_{b g} )}^{⊤} f ( {s}_{i} ) )}{{Σ}_{k = 1}^{T} g ( {f ( {s}_{b g} )}^{⊤} f ( {s}_{k} ) )} f ( {s}_{i} ) \qquad ( 10 )$$

By such weighting mechanism, the first challenge (i.e., untrimmed video with weak supervision) is also solved by softly learning to distinguish BG and FG. Combining all of the above, the model is trained with:

$$L = {L}_{cls \text{-} soft} + {γ}_{1} {L}_{contrast} + {γ}_{2} {L}_{bg \text{-} c l s} \qquad ( 11 )$$

where:
γ₁ and γ₂ are hyper-parameters.

With the methods disclosed herein, the model is capable of capturing informative objects and movements in IBG, and is still able to distinguish BG and FG, therefore helping the recognition.

In one embodiment, the model is implemented in the open-source platform TensorFlow and executed on processor, for example, a PC or a server having a graphics processing unit. Other embodiments implementing the model are contemplated to be within the scope of the invention.

In one embodiment, the feature extractor comprises a ResNet50, a spatial convolution layer and a temporal depth-wise convolution layer. One embodiment of a network structure suitable for used with the method disclosed herein is shown in FIG. 3. For each untrimmed video, its RGB frames are extracted at 25 FPS with a resolution of 256×256. Each video into an average of 100 video segments and 8 frames are sampled for each segment (i.e., T=100, t=8). The image features are extracted by ResNet50, which is pre-trained on ImageNet and then fixed for saving GPU memory. Then there is a spatial convolution layer and a depth-wise convolution layer for the feature embedding and dataset-specific information learning, which are trained from scratch. Only the RGB stream is used.

A method and model has been disclosed herein to reduce the annotation of both the large amount of data and action locations. To address the challenges involved, disclosed herein is (1) an open-set detection based method to find the NBG and FG; (2) a contrastive learning method for self-supervised learning of IBG and distinguishing NBG; and (3) a self-weighting mechanism for the better learning of IBG and FG.

1. A method for training a base class model to recognize novel classes in untrimmed videos clips comprising:
training a base class model, supervised only by class labels, to classify and localize actions in untrimmed videos clips comprising multiple video segments, the video segments containing non-informative background, informative background or foreground; and
further training the base class model to classify and localize novel classes using a training data set comprising few trimmed video segments of actions comprising the novel class.

2. The method of claim 1 further comprising:
exposing the base class model to untrimmed testing video segments comprising action in the novel class;
wherein the base class model is able to classify and localize the action depicted in the novel class.

3. The method of claim 1 wherein video segments containing foreground are video segments containing an action which the base class model is trained to recognize.

4. The method of claim 1 wherein video segments containing informative background are video clips containing informative objects or actions which the base class model is not trained to recognize.

5. The method of claim 1 wherein video segments containing non-informative background are video clips not containing informative objects or actions.

6. The method of claim 1 wherein training the base class model comprises:
distinguishing video segments containing non-informative background from video segments containing either informative background or foreground; and
compressing a feature space in the base class model of video segments containing non-informative background.

7. The method of claim 6 wherein training the base class model comprises:
extracting a feature from untrimmed video segments in a base class dataset;
determining a maximum classification probability of each video clip;
pseudo-labelling a video clip as non-informative background when the maximum classification probability for that video clip falls below a threshold; and
measuring the confidence score as the maximum value of each segment's classification probabilities, and pseudo-labelling video segments having the highest confidence scores as foreground or informative background.

8. The method of claim 7 further comprising:
defining as a negative pair a feature extracted from non-informative background video segments and a feature extracted from both informative background and foreground segments.

9. The method of claim 8 further comprising:
enlarging a distance in the base class model between features in the negative pair by minimizing the contrastive loss.

10. The method of claim 9 further comprising:
defining as a positive pair features extracted from non-informative background video segments.

11. The method of claim 10 further comprising:
reducing a distance in the base class model between features in the positive pair by minimizing the contrastive loss.

12. The method of claim 1 further comprising:
distinguishing between video segments containing foreground and informative background by automatically learning a different weight for each segment using a self-weighting mechanism by using a transformed similarity between each video segment and the pseudo-labelled background segment of the given video.

13. The method of claim 1 wherein classifying and localizing novel classes further comprises:
extracting features from video segments containing the novel classes and performing a nearest neighbor match to features extracted from the trimmed training video segments in the novel class.

14. A system comprising:
a processor;
software, executing on the processor, the software performing the functions of:
training a base class model, supervised only by class labels, to classify and localize actions in untrimmed videos clips comprising multiple video segments, the video segments containing non-informative background, informative background or foreground; and
further training the base class model to classify and localize novel classes in untrimmed video clips using a training data set comprising few trimmed video segments of actions comprising the novel class.

15. The system of claim 14 wherein the software is implemented in Tensorflow.
